(19) United States
(12) Patent Application Publication
(10) Pub. No.: US 2016/0264746 A1
(43) Pub. Date: Sep. 15, 2016

(54) FOAM COMPOSITE AND METHODS OF MAKING THE SAME

(71) Applicant: TEMPUR-PEDIC MANAGEMENT, LLC, Lexington, KY (US)

(72) Inventor: Carlotta M. Paulsen, Kingsport, TN (US)

(73) Assignee: Tempur-Pedic Management, LLC, Lexington, KY (US)

(21) Appl. No.: 14/776,936

(22) PCT Filed: Mar. 15, 2015
(86) PCT No.: PCT/US2013/032018

§ 371 Date: Sep. 15, 2015

(51) Int. Cl. C08J 9/00

(52) U.S. Cl. CPC C08J 9/0061; C08J 2375/04; C08J 2423/06; C08J 2201/022

(57) ABSTRACT

A foam composite includes a matrix and a plurality of fibers embedded in the matrix. The matrix can include viscoelastic foam. Also disclosed herein are methods of manufacturing such a foam composite.

### FIELD OF THE INVENTION

The present invention relates to foam composites, and more particularly to foam composites including fibers.

### BACKGROUND OF THE INVENTION

Foam is often used in body supports such as mattresses, cushions, and slippers. Some foams have desirable characteristics such as cell size, recovery time, and hardness, but fail to have adequate tensile strength for use in the body support. Such foams can be reformulated to have adequate tensile strength for use in the body support. Reformulation of the foam, however, often adversely changes other properties of the foam, for example, hardness and recovery time.

### SUMMARY OF THE INVENTION

The invention provides, in one aspect, a foam composite including a matrix and a plurality of fibers embedded in the matrix.

The matrix may include viscoelastic foam. The fibers may include at least one of natural fibers and synthetic fibers. The fibers may include a material selected from a group consisting of polyethylene, polypropylene, rayon, nylon, polyester, and any combination thereof. The polyethylene material may include at least one of low melt polyethylene, ultra-high molecular weight polyethylene, and E380F fibrillated high density polyethylene.

The fibers may include at least one of chemically interactive fibers and chemically inert fibers. The chemically interactive fibers may include at least one of rayon fibers, nylon fibers, and polyester fibers. The chemically inert fibers may include at least one of polyethylene fibers and polypropylene fibers. The polyethylene fibers may include at least one of low melt polyethylene fibers, ultra-high molecular weight polyethylene fibers, and E380F fibrillated high density polyethylene fibers.

The fibers may have a chop length of at least about 0.1 mm and no greater than about 5 mm. The fibers may have a chop length of at least about 0.7 mm and no greater than about 3.175 mm (⅛ inch). The fibers may have a diameter of at least about 14 microns and no greater than about 124 microns. The fibers may have a denier of at least about 1.3 dpf and no greater than about 10 dpf. The fibers may have a specific gravity of at least about 0.9 g/cm³ and no greater than about 1.5 g/cm³. The fibers may occupy less than about 5% by weight of the foam composite. The fibers may occupy less than about 2% by weight of the foam composite. The fibers may be present in an amount of about 0.65% to about 1.5% by weight of the foam composite.

The fibers may chemically interact with the viscoelastic foam in the matrix. In other embodiments, however, the fibers may be inert and may not chemically interact with the viscoelastic foam in the matrix. The viscoelastic foam may include a density of no less than about 30 kg/m³ and no greater than about 150 kg/m³. The viscoelastic foam may include a density of about 40 kg/m³. A dynamic fatigue hardness loss of the foam composite may be less than a dynamic fatigue hardness loss of the matrix alone. The dynamic fatigue hardness loss of the foam composite may be less than about 50% of the dynamic fatigue hardness loss of the matrix alone.

The viscoelastic foam may include a density of about 80 kg/m³. A dynamic fatigue hardness loss of the foam composite may be greater than a dynamic fatigue hardness loss of the matrix alone. The dynamic fatigue hardness loss of the foam composite may be about 32% greater than the dynamic fatigue hardness loss of the matrix alone.

The viscoelastic foam may include a hardness of at least about 20 N and no greater than about 80 N. The foam composite may have a tensile strength of about 10% to about 60% greater than a tensile strength of the matrix alone. The tensile strength may be a vertical tensile strength. The vertical tensile strength may be about 14% to about 53% greater than a vertical tensile strength of the matrix alone. The tensile strength may be a horizontal tensile strength. The horizontal tensile strength of the foam composite may be about 37% greater than a horizontal tensile strength of the matrix alone.

The foam composite may have an air permeation of at least about 3 times greater than an air permeation of the matrix alone.

The fibers may extend in generally the same direction within the matrix. In other embodiments, however, the fibers may be randomly oriented within the matrix. The fibers may have a shape including at least one of a branched shape and an unbranched shape. The fibers having the unbranched shape may include a cross-sectional shape of at least one of an irregular cross-sectional shape and a lobed cross-sectional shape. The fibers having the unbranched shape may extend in generally the same direction within the matrix. The fibers having the branched shape may be randomly oriented within the matrix.

The invention provides, in another aspect, a method of manufacturing a foam composite. The method includes providing fibers, a polyol, and an isocyanate, and mixing the fibers and one of the polyol and the isocyanate to form a first mixture. The method also includes adding the other of the polyol and the isocyanate to the first mixture to form a second mixture. The method further includes expanding the second mixture into the foam composite.

Mixing may occur at a speed of at least about 1000 rpm. In some embodiments, mixing may occur at a speed of about 1000 rpm to about 3000 rpm. Providing the fibers may include selecting fibers having a diameter of less than about 124 microns. The method may further include chopping the fibers to a length of less than about 5 mm prior to mixing the fibers. Expanding the second mixture may occur along an axis. Expanding the second mixture may cause the fibers to align in a direction that is generally parallel with the axis of expansion. In other embodiments, expanding the second mixture may cause the fibers to align in a direction that is generally perpendicular with the axis of expansion. Providing the fibers may include providing at least one of natural fibers and synthetic fibers. Providing the fibers may include selecting materials from a group consisting of low melt polyethylene, ultra-high molecular weight polyethylene, E380F fibrillated polyethylene pulp, polypropylene, rayon, nylon, polyester, and any combination thereof.

Other features and aspects of the invention will become apparent by consideration of the following detailed description.

### BRIEF DESCRIPTION OF THE DRAWINGS

FIG. 1 is a perspective view of a mattress, in which a cutaway illustrates a foam composite in accordance with an embodiment of the invention.

FIG. 1A is a detailed view of the foam composite of FIG. 1.

FIG. 2 is a detailed view of a foam composite in accordance with a second embodiment of the invention.

Before any embodiments of the invention are explained in detail, it is to be understood that the invention is not limited in its application to the details of construction and the arrangement of components set forth in the following description. The invention is capable of other embodiments and of being practiced or of being carried out in various ways. Also, it is to be understood that the phraseology and terminology used herein is for the purpose of description and should not be regarded as limiting.

### DETAILED DESCRIPTION

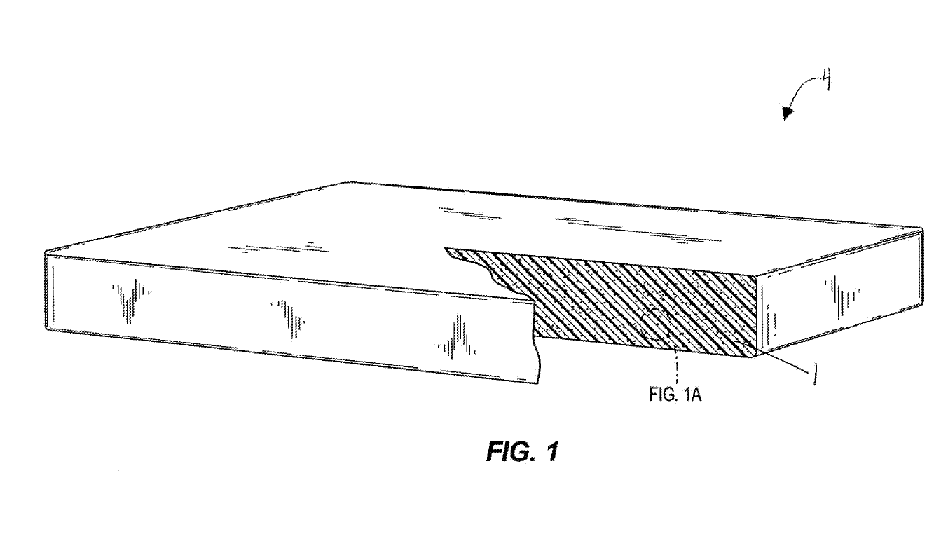

As illustrated in FIG. 1, the present invention relates to a foam composite 1 for use in a body support 4 (e.g., slippers, cushions, pillows, mattresses, etc.). The foam composite 1 includes a matrix 8 and fibers 12 embedded in the matrix 8 (FIG. 1A). The matrix 8 can include one or more types of foam. Many foams have desirable characteristics such as cell size, recovery time, glass transition temperature, hardness, and tan delta. Many of these foams, however, do not meet performance standards (e.g., tensile strength, dynamic fatigue, etc.) for use in body supports 4 like slippers, cushions, pillows, and mattresses. By embedding fibers 12 in the matrix 8, and thus the foam, the foam composite 1 can have an improved performance (e.g., increased tensile strength) as compared to the foam alone, thereby meeting performance standards for use in the body support 4. Additionally, the foam composite 1 may maintain the desirable characteristics of the foam. In other embodiments, the embedded fibers 12 may alter or improve the desirable characteristics of the foam.

The foam may be viscoelastic foam or non-viscoelastic foam (e.g., latex foam, high-resilience (HR) polyurethane foam, etc.). The viscoelastic foam may be polyurethane foam. Viscoelastic foam is sometimes referred to as “memory foam” or “low resilience foam.” Coupled with the slow recovery characteristic of viscoelastic foam, the foam composite 1 can at least partially conform to a user's body or body portion (e.g., head, hips, feet, and the like; hereinafter referred to as “body”), thereby distributing the force applied by the user's body upon the foam composite 1. The foam composite 1 can provide a relatively soft and comfortable surface for the user's body.

In some embodiments, the viscoelastic foam has a hardness of at least about 20 N and no greater than about 80 N for desirable softness and body-conforming qualities. Alternatively, the viscoelastic foam may have a hardness of at least about 30 N and no greater than about 70 N. In still other alternative embodiments, the viscoelastic foam may have a hardness of at least about 40 N and no greater than about 60 N. Unless otherwise specified, the hardness of a material referred to herein is measured by exerting pressure from a plate against a sample of the material to a compression of 40 percent of an original thickness of the material at approximately room temperature (e.g., 21 to 23 degrees Celsius). The 40 percent compression is held for a set period of time, following the International Organization of Standardization (ISO) 2439 hardness measuring standard.

The viscoelastic foam can also have a density providing a relatively high degree of material durability. The density of the viscoelastic foam can impact other characteristics of the foam composite 1, such as the manner in which the foam composite 1 responds to pressure, and the feel of the foam composite 1. In some embodiments, the viscoelastic foam has a density of no less than about 30 kg/m³ and no greater than about 150 kg/m³. Alternatively, the viscoelastic foam may have a density of at least about 40 kg/m³ and no greater than about 135 kg/m³. In still other alternative embodiments, the viscoelastic foam may have a density of at least about 50 kg/m³ and no greater than about 120 kg/m³.

The viscoelastic foam can be made from non-reticulated or reticulated viscoelastic foam. Reticulated viscoelastic foam has characteristics that are well suited for use in the foam composite, including the enhanced ability to permit fluid movement through the reticulated viscoelastic foam, thereby providing enhanced air and/or heat movement within, through, and away from the foam composite 1. Reticulated foam is a cellular foam structure in which the cells of the foam are essentially skeletal. In other words, the cells of the reticulated foam are each defined by multiple apertured windows surrounded by struts. The cell windows of the reticulated foam can be entirely gone (leaving only the cell struts) or substantially gone. For example, the foam may be considered “reticulated” if at least 50 percent of the windows of the cells are missing (i.e., windows having apertures therethrough, or windows that are completely missing and therefore leaving only the cell struts). Such structures can be created by destruction or other removal of cell window material, or preventing the complete formation of cell windows during the manufacturing process.

In an alternative embodiment of the foam composite 1, the matrix 8 may include a non-viscoelastic foam such as a latex foam or a HR polyurethane foam. Such a latex foam may have a hardness of at least about 30 N and no greater than about 130 N for a desirable overall foam composite 1 firmness and “bounce.” In still other alternative embodiments, the latex foam may have a hardness of at least about 40 N and no greater than about 120 N, or at least about 50 N and no greater than about 110 N. In some embodiments, the latex foam has a density of no less than about 40 kg/m³ and no greater than about 100 kg/m³. In still other alternative embodiments, the latex foam may have a density of at least about 50 kg/m³ and no greater than about 100 kg/m³, or at least about 60 kg/m³ and no greater than about 100 kg/m³.

In an alternative embodiment of the foam composite 1 in which the matrix 8 includes HR polyurethane foam, such a foam may include an expanded polymer (e.g., expanded ethylene vinyl acetate, polypropylene, polystyrene, or polyethylene), and the like. In some embodiments, the HR polyurethane has a hardness of at least about 80 N and no greater than about 200 N for a desirable overall foam composite 1 firmness and “bounce.” In still other alternative embodiments, the HR polyurethane foam may have a hardness of at least about 90 N and no greater than about 190 N, or at least about 100 N and no greater than about 180 N.

The HR polyurethane foam may have a density which provides a reasonable degree of material durability to the foam composite 1. The HR polyurethane foam may also impact other characteristics of the foam composite 1, such as the manner in which the foam composite 1 responds to pressure. In some embodiments, the HR polyurethane foam has a density of no less than about 10 kg/m³ and no greater than about 80 kg/m³. In still other alternative embodiments, the HR polyurethane foam may have a density of no less than about 15 kg/m³ and no greater than about 70 kg/m³, or no less than about 20 kg/m³ and no greater than about 60 kg/m³.

As discussed above, the foam composite 1 includes fibers 12 embedded in the matrix 8 (FIG. 1A). The fibers 12 can be natural fibers or synthetic fibers. In some embodiments, the fibers 12 may be basophil (i.e., melamine) fibers, polylactic acid (i.e., PLA) fibers, or polyvinyl alcohol (i.e., PVA) fibers. In other embodiments, the fibers 12 can interact with the viscoelastic foam in the matrix 8. The interaction can be a chemical interaction such as a covalent bond or an intermolecular interaction. The intermolecular interaction can include, but is not limited to, hydrogen bonding, van der Waals forces, dipole-dipole forces, and hydrophobic interactions. The interactive fibers 12 can include any number of fibers or materials, for example, rayon fibers, nylon fibers, and polyester fibers. In some embodiments, the rayon fibers may be trilobal.

In still other embodiments, the fibers 12 can be inert and not chemically interact with the viscoelastic foam in the matrix 8. The inert fibers 12 can include any number of fibers or materials, for example, polyethylene fibers and polypropylene fibers. In some embodiments, the polyethylene fibers may include low melt polyethylene fibers, ultra-high molecular weight polyethylene fibers, and E380F fibrillated high density polyethylene fibers (i.e., “short stuff”). Low melt polyethylene may also be known as synthetic linear low-density polyethylene or LLDPE. Low melt polyethylene has a molecular weight of 35,000 Daltons, a melting point of 123 degrees Celsius, and a breaking tenacity of 1.0 gram of breaking force per denier of fiber (i.e., gpd). Ultra-high molecular weight polyethylene may also be known as synthetic high-modulus polyethylene, HMPE, high performance polyethylene, or HPPE. Ultra-high molecular weight polyethylene has a molecular weight of 4.5 to 6 million Daltons, a melting point of 147 degrees Celsius, and a breaking tenacity of 25.5 to 30.5 gpd.

The fibers 12 can have a chop length of at least about 0.05 millimeters (i.e., mm) and no greater than about 10 mm. Alternatively, the fibers 12 may have a chop length of at least about 0.1 mm and no greater than about 5 mm. In still other alternative embodiments, the fibers 12 may have a chop length of at least about 0.7 mm and no greater than about 3.175 mm (i.e., ⅛ inch). The fibers 12 can have the same chop length. Alternatively, the fibers 12 may have a randomized chop length.

The fibers 12 can also have a diameter of at least about 1 micron and no greater than about 250 microns. Alternatively, the fibers 12 can have a diameter of at least about 8 microns and no greater than about 185 microns. In still other alternative embodiments, the fibers 12 can have a diameter of at least about 14 microns and no greater than about 124 microns. The diameter of the fibers 12 can be related to the fiber unit denier (i.e., dpf). Particularly, the diameter (in microns) equals 11.89 times the square root of the denier (i.e., dpf) divided by the density (in grams per mL or grams per cm³) of the fiber 12. Accordingly, fibers 12 of the same denier can have different diameters should the density of the respective materials from which they are made differ. In some embodiments, the fibers 12 can have a denier of at least about 0.1 dpf and no greater than about 20 dpf. Alternatively, the fibers 12 may have a denier of at least about 0.6 dpf and no greater than about 15 dpf. In still other alternative embodiments, the fibers 12 may have a denier of at least about 1.3 dpf and no greater than about 10 dpf.

The diameter and the chop length of the fibers 12 can be expressed as a ratio (i.e., chop length/diameter), which may also be known as an aspect ratio of the fibers 12. The aspect ratio of the fibers 12 can be at least about 0.0005 mm/micron and no greater than about 1 mm/micron. Alternatively, the aspect ratio of the fibers 12 may be at least about 0.0025 mm/micron and no greater than about 0.50 mm/micron. In still other alternative embodiments, the aspect ratio of the fibers 12 may be at least about 0.005 mm/micron and no greater than about 0.25 mm/micron.

The fibers 12 can have a specific gravity of at least about 0.09 grams per cubic centimeter (i.e., g/cm³) and no greater than about 15 g/cm³. Alternatively, the fibers 12 may have a specific gravity of at least about 0.1 g/cm³ and no greater than about 8 g/cm³. In still other alternative embodiments, the fibers 12 may have a specific gravity of at least about 0.9 g/cm³ and no greater than about 1.5 g/cm³. In further embodiments, the fibers 12 may have the features listed below in Table 1.

TABLE 1

| | Denier | Specific gravity | Diameter |
|---|---|---|---|
| Fiber | (dpf) | (g/cm³) | (microns) |
| Basofil | 2.4 | 1.4 | 15.6 |
| Nylon | 3.0 | 1.14 | 19.3 |
| PLA (polylactic acid) | 1.3 | 1.25 | 12.1 |
| Polyester | 3.0 | 1.38 | 17.5 |
| Polyethylene, low melt | 6 | 0.96 | 74.3 |
| Polyethylene, UHMW | 10 | 0.96 | 123.8 |
| Polypropylene | 1.5 | 0.90 | 15.3 |
| PVA (polyvinyl alcohol) | 1.8 | 1.3 | 14.0 |
| Rayon | 4.5 | 1.5 | 20.6 |
| Rayon, trilobal | 3.0 | 1.5 | 16.8 |
| ‘Short stuff’ E380F fibrillated high | | | 15 |
| density polyethlyene | | | |

The fibers 12 can occupy less than about 5% by weight of the foam composite 1. Alternatively, the fibers 12 may occupy less than about 2% by weight of the foam composite 1. In still other alternative embodiments, the fibers 12 are present in an amount of about 0.65% to about 1.5% by weight of the foam composite 1. In some embodiments, the density of the fibers 12 can be varied by holding the percent by weight of the foam composite 1 constant, but changing the denier of the fibers 12. In still other alternative embodiments, the fibers 12 can occupy about 1 parts per hundred polyol (i.e., pphp) or about 0.5 pphp when the foam of the matrix is made from a polyol.

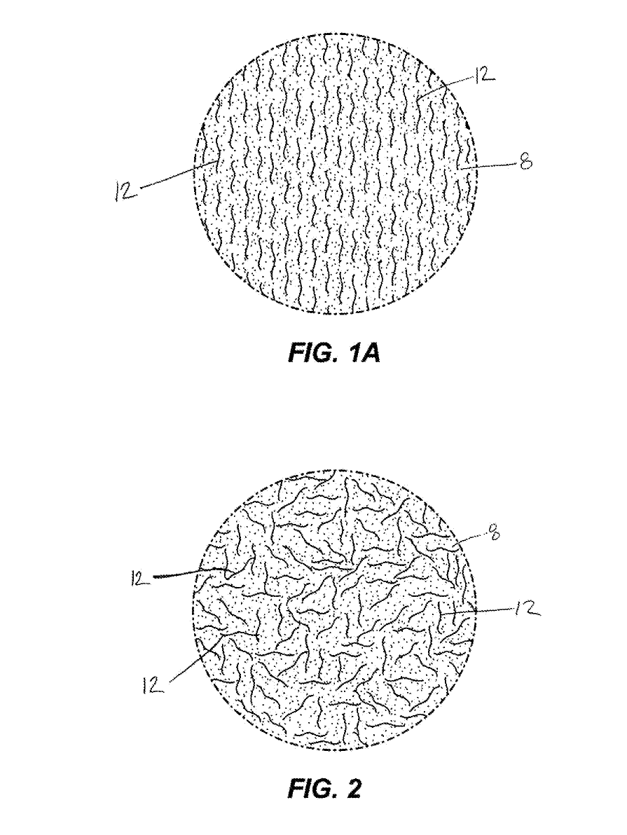

The fibers 12 can have an unbranched shape or a branched shape. The unbranched fibers 12 can have a cross-sectional shape that is irregular or lobed (i.e., having one or more distinct lobes or curved projection(s) as opposed to a circular cross-sectional shape). The unbranched fibers 12 can be parallel to or aligned with each other within the matrix 8 (FIG. 1A). In other words, the unbranched fibers 12 may extend in generally the same direction within the matrix. The branched fibers 12 can also be known as fibrillated fibers. The branched fibers 12 can be randomly oriented or aligned within the matrix 8. Alternatively, some of the branched fibers 12 may extend in a vertical direction within the matrix 8, while other branched fibers 12 may extend in a horizontal direction within the matrix 8 (FIG. 2).

The foam composite 1 can include both gross or macroscale properties and microscale properties that can be different from the macroscale and/or microscale properties of the matrix 8 alone. Macroscale properties can include, but are not limited to, tensile strength, dynamic fatigue, and compression set. Microscale properties can include, but are not limited to, glass transition temperature, hardness, and recovery time. The macroscale and/or microscale properties of the foam composite 1 can be altered by the type of fiber 12 (e.g., chemically interactive fibers, chemically inert fibers, etc.) embedded in the matrix 8.

In one example, a foam composite 1 including chemically inert fibers 12 may have improved or greater tensile strength, dynamic fatigue, compression set, or a combination thereof as compared to the matrix alone without alteration of the microscale properties. In other words, the chemically inert fibers 12 can lend strength to the foam composite 1 without altering the chemical composition of the matrix 8. In a second example, a foam composite 1 including chemically interactive fibers 12 may have both improved macroscale properties, and altered or changed microscale properties as compared to the matrix 8 alone.

The foam composite 1 can have a tensile strength of about 5% to about 80% greater than a tensile strength of the matrix 8 alone. Alternatively, the foam composite 1 may have a tensile strength of about 10% to about 60% greater than a tensile strength of the matrix 8 alone. In still other alternative embodiments, the foam composite 1 may have a tensile strength of about 14% to about 53% greater than a tensile strength of the matrix 8 alone. The tensile strength can be measured in either a vertical direction (hereinafter “vertical tensile strength”), or a horizontal direction (hereinafter “horizontal tensile strength”). The vertical tensile strength can extend in generally the same direction as the direction in which the viscoelastic foam in the matrix 8 expanded or rose during formation of the viscoelastic foam (i.e., foam rise profile or axis of expansion). In other words, the vertical tensile strength can extend in a direction generally parallel to the axis of the foam expansion. The vertical tensile strength of the foam composite can be about 5% to about 80% greater than a vertical tensile strength of the matrix alone. Alternatively, the vertical tensile strength of the foam composite 1 may be about 10% to about 60% greater than a vertical tensile strength of the matrix 8 alone. In still other alternative embodiments, the vertical tensile strength of the foam composite 1 may be about 14% to about 53% greater than a vertical tensile strength of the matrix 8 alone.

In other embodiments, the tensile strength may be a horizontal tensile strength. The horizontal tensile strength may extend in a direct generally perpendicular to the axis of foam expansion. The horizontal tensile strength of the foam composite 1 may be at about 17% to about 57% greater than a horizontal tensile strength of the matrix 8 alone. Alternatively, the horizontal tensile strength of the foam composite 1 may be about 27% to about 47% greater than a horizontal tensile strength of the matrix 8 alone. In still other alternative embodiments, the horizontal tensile strength of the foam composite 1 may be about 37% greater than a horizontal tensile strength of the matrix 8 alone.

Other characteristics of the foam composite 1 can include the foam rise profile or the axis of expansion, and the gel time of the viscoelastic foam in the matrix 8. Gel time can be the time required for the viscoelastic foam to solidify during formation of the viscoelastic foam. Additional characteristics may include the glass transition temperature (T_{g}) and tan delta of the viscoelastic foam. Tan delta can be a measure of the viscoelasticity of foam. The fibers 12 embedded in the matrix 8 of the foam composite 1 may not substantially alter or change the foam rise profile, gel time, glass transition temperature, and/or tan delta of the viscoelastic foam.

A hardness of the viscoelastic foam in the matrix 8 can be unaltered or unchanged by the fibers 12 embedded in the matrix 8 of the foam composite 1. Alternatively, the hardness of the viscoelastic foam in the matrix 8 may be altered or changed by the fibers 12 embedded in the matrix 8 of the foam composite 1. In still other alternative embodiments, the hardness of the viscoelastic foam may be altered or changed when the fibers 12 in the matrix 8 of the foam composite 1 are polyester fibers.

The foam composite 1 can have a dynamic fatigue hardness loss. The dynamic fatigue hardness loss can be less than the dynamic fatigue hardness loss of the matrix 8 alone. In some embodiments, the dynamic fatigue hardness loss of the foam composite 1 can be less than about 50% of the dynamic fatigue hardness loss of the matrix 8 alone. The matrix 8 of such a foam composite 1 can include a microcellular foam having a density of about 40 kg/m³. In other embodiments, the dynamic fatigue hardness loss of the foam composite 1 may be greater than a dynamic fatigue hardness loss of the matrix 8 alone. In still other alternative embodiments, the dynamic fatigue hardness loss of the foam composite 1 may be about 32% greater than the dynamic fatigue hardness loss of the matrix 8 alone. The matrix 8 of such a foam composite 1 may include a large-cell foam having a density of about 80 kg/m³.

The foam composite 1 can have an air permeation of about 1.5 times to about 6 times greater than an air permeation of the matrix 8 alone. Air permeation is the flow rate of air through the foam composite 1. Alternatively, the foam composite 1 may have an air permeation of about 2 times to about 4 times greater than an air permeation of the matrix 8 alone. In still other alternative embodiments, the foam composite 1 may have an air permeation of about 3 times greater than an air permeation of the matrix 8 alone.

In other embodiments, the foam composite 1 may have the macroscale properties listed below in Table 2.

TABLE 2

| | | Dose (% | |
|---|---|---|---|
| Foam | Fiber | by weight) | Results |
| Microcellular | Short stuff | 0.65 | 25% increase in |
| foam | | | vertical tensile |
| (40 kg/m³) | | | strength, dramatic |
| | | | drop (>70%) in |
| | | | dynamic fatigue |
| | | | hardness loss |
| | Polypropylene, | 0.65 | 22% increase in |
| | 1.5 dpf | | vertical tensile, |
| | | | dramatic drop in |
| | | | dynamic fatigue |
| | | | hardness loss |
| | Polyethylene, low | 0.65 | 14% increase in |
| | melt, 6 dpf | | vertical tensile |
| | | | strength, dramatic |
| | | | drop in dynamic |
| | | | fatigue hardness loss |
| | Polyethylene, | 0.65 | 21% increase in |
| | UHMW, 10 dpf | | vertical tensile |
| | | | strength, 14% drop in |
| | | | dynamic fatigue |
| | | | hardness loss |
| | Rayon, 4.5 dpf | 0.65 | Enhanced air |
| | | | permeation (>3 times |
| | | | reference sample) |
| | Nylon, 3.0 dpf | 0.65 | Enhanced air |
| | | | permeation (>3 times |
| | | | reference sample) |
| | Polyester, 3.0 dpf | 0.65 | Enhanced air |
| | | | permeation (>3 times |
| | | | reference sample) |
| | Rayon, 4.5 dpf | 1.0 | 46% increase in |
| | | | vertical tensile |
| | | | strength |
| | Polyester, 3.0 dpf | 1.5 | 18% increase in |
| | | | vertical tensile |
| | | | strength |
| Large-cell | Short stuff | 0.8 | 53% increase in |
| foam | | | vertical tensile and |
| (80 kg/m³) | | | 37% increase in |
| | | | horizontal tensile |
| | | | strength, 32% |
| | | | improved dynamic |
| | | | fatigue hardness loss |

In manufacturing the foam composite 1, a polyol and an isocyanate can be used to make the viscoelastic foam in the matrix 8. In some embodiments, the fibers 12 can be embedded or placed in the matrix 8 by mixing or combining the fibers 12 with the polyol to form a first mixture. Mixing can occur at speeds of at least about 1000 rpm. Alternatively, mixing may occur at speeds of about 1000 rpm to about 3000 rpm. Prior to mixing the fibers 12 and polyol, the fibers 12 can be chopped or divided into lengths (e.g., 0.7 mm, ⅛ inch, etc.) to prevent tangling of the fibers 12 during mixing. The isocyanate can then be added to the first mixture to form a second mixture. The second mixture can be expanded or rise into the foam composite.

In alternative embodiments of manufacturing the foam composite 1, the fibers 12 may be embedded in the matrix 8 by mixing the fibers 12 with the isocyanate to form the first mixture. The polyol may be added to the first mixture to form the second mixture, which may be expanded or rise into the foam composite 1.

When the second mixture expands into the foam composite 1, the expansion can cause the fibers 12 to align in a direction that is generally parallel with the axis of expansion. In some embodiments, the fibers 12 aligned parallel with the axis of the expansion can be unbranched fibers. In other embodiments, alignment of the fibers 12 parallel to the axis of expansion may improve the tensile strength of the foam composite 1 as compared to the matrix 8 alone. Such an improvement may be an improvement in the vertical tensile strength because the unbranched fibers 12 are aligned parallel with the axis of expansion.

Alternatively, expansion may cause some of the fibers 12 to align in a direction generally parallel with the axis of expansion, while other fibers 12 may align in a direction generally perpendicular with the axis of expansion. In some embodiments, fibers 12 aligning parallel and perpendicular to the axis of expansion may be branched fibers. In other embodiments, alignment of the fibers 12 both parallel and perpendicular to the axis of expansion may improve the tensile strength of the foam composite 1 as compared to the matrix 8 alone. Such an improvement may be an improvement in the both the vertical and horizontal tensile strengths because the branched fibers 12 align parallel and perpendicular to the axis of expansion. In other words, parallel alignment of the fibers 12 may improve the vertical tensile strength of the foam composite 1 as compared to the matrix 8 alone, while perpendicular alignment of the fibers 12 may improve the horizontal tensile strength of the foam composite 1 as compared to the matrix 8 alone.

In some embodiments, expanding the second mixture can include the rise of bubbles or vesicles along the axis of expansion, thereby promoting the rise of the viscoelastic foam in the matrix 8 of the foam composite 1. Such bubbles can be, but are not limited to, carbon dioxide bubbles. The bubbles may aide in the alignment of the fibers 12 during the rise of the bubbles along the axis of expansion.

Various features of the invention are set forth in the following claims.

1. A foam composite comprising:
a matrix including viscoelastic foam;
a plurality of fibers embedded in the matrix;
wherein the fibers include at least one of natural fibers and synthetic fibers;
wherein the fibers include polyethylene and wherein the polyethylene includes at least one of low melt polyethylene, ultra-high molecular weight polyethylene, and E380F fibrillated high density polyethylene.

2. (canceled)

3. (canceled)

4. (canceled)

5. A foam composite comprising:
a matrix including viscoelastic foam;
a plurality of fibers embedded in the matrix; and
wherein the fibers include at least one of chemically interactive fibers and chemically inert fibers.

6. The foam composite of claim 5, wherein the chemically interactive fibers include at least one of rayon fibers, nylon fibers, and polyester fibers.

7. The foam composite of claim 5, wherein the chemically inert fibers include at least one of polyethylene fibers and polypropylene fibers.

8. The foam composite of claim 7, wherein the polyethylene fibers include at least one of low melt polyethylene fibers, ultra-high molecular weight polyethylene fibers, and E380F fibrillated high density polyethylene fibers.

9. (canceled)

10. (canceled)

11. (canceled)

12. (canceled)

13. (canceled)

14. (canceled)

15. (canceled)

16. (canceled)

17. The foam composite of claim 1, wherein the fibers chemically interact with the viscoelastic foam in the matrix.

18. The foam composite of claim 1, wherein the fibers are inert and do not chemically interact with the viscoelastic foam in the matrix.

19. (canceled)

20. (canceled)

21. The foam composite of claim 1, wherein a dynamic fatigue hardness loss of the foam composite is less than a dynamic fatigue hardness loss of the matrix alone.

22. The foam composite of claim 21, wherein the dynamic fatigue hardness loss of the foam composite is less than about 50% of the dynamic fatigue hardness loss of the matrix alone.

23. (canceled)

24. (canceled)

25. (canceled)

26. (canceled)

27. The foam composite of claim 1, wherein the foam composite has a tensile strength of about 10% to about 60% greater than a tensile strength of the matrix alone.

28. The foam composite of claim 27, wherein the tensile strength is a vertical tensile strength.

29. (canceled)

30. The foam composite of claim 27, wherein the tensile strength is a horizontal tensile strength.

31. The foam composite of claim 30, wherein the horizontal tensile strength of the foam composite is about 37% greater than a horizontal tensile strength of the matrix alone.

32. The foam composite of claim 1, wherein the foam composite has an air permeation of at least about 3 times greater than an air permeation of the matrix alone.

33. The foam composite of claim 1, wherein the fibers extend in generally the same direction within the matrix.

34. The foam composite of claim 1, wherein the fibers are randomly oriented within the matrix.

35. (canceled)

36. (canceled)

37. (canceled)

38. (canceled)

39. A method of manufacturing a foam composite, the method comprising:
providing fibers, a polyol, and an isocyanate;
mixing the fibers and one of the polyol and the isocyanate to form a first mixture;
adding the other of the polyol and the isocyanate to the first mixture to form a second mixture; and
expanding the second mixture into the foam composite.

40. The method of claim 39, wherein mixing occurs at a speed of at least about 1000 rpm.

41. (canceled)

42. (canceled)

43. (canceled)

44. The method of claim 39, wherein expanding the second mixture occurs along an axis.

45. The method of claim 39, wherein expanding the second mixture causes the fibers to align in a direction that is generally parallel with the axis of expansion.

46. The method of claim 45, wherein expanding the second mixture causes the fibers to align in a direction that is generally perpendicular with the axis of expansion.

47. (canceled)

48. (canceled)
